(19) United States
(12) Patent Application Publication
(10) Pub. No.: US 2012/0064342 A1
(43) Pub. Date: Mar. 15, 2012

(54) PARTICLE-LOADED FIBER AND METHODS FOR MAKING

(76) Inventors: Atanas Valentinov Gagov, Painted Post, NY (US); James William Zimmermann, Corning, NY (US)

(21) Appl. No.: 13/322,369

(22) PCT Filed: May 25, 2010
(86) PCT No.: PCT/US10/36008

§ 371 Date: Nov. 23, 2011

Related U.S. Application Data
(60) Provisional application No. 61/182,398, filed on May 29, 2009.

(51) Int. Cl. B01J 31/02; B01J 31/06; D01D 5/12; B01J 31/38; D02G 3/00; B01J 37/00; B01J 31/26

(52) U.S. Cl. 428/372; 502/439; 428/401; 264/210.8

(57) ABSTRACT

Particle-loaded fibers include a fiber body having inorganic particles bound together by an organic binder. The fiber body has a diameter less than about 150 μm, and the inorganic particles comprise a particle density of greater than 20%, 30%, 40% or even 50% by volume of the fiber body. Methods for producing such particle loaded fibers include extruding a composition through a die orifice having a diameter of less than 1000 μm to form a fiber having a first diameter, and drawing the fiber from the first diameter to a smaller second diameter of less than 150 μm, wherein the inorganic particles are greater than 50% by weight of the extruded composition.

### CROSS-REFERENCE TO RELATED APPLICATIONS

This application claims the benefit of priority to U.S. provisional application No. 61/182,398, filed on May 29, 2009.

### FIELD

This disclosure generally relates to fibers comprising inorganic particles loaded in an organic binder.

### BACKGROUND

Processes and compositions for the production of highly porous ceramic articles for filter and substrate applications are disclosed, for example, in U.S. patent application Ser. No. 12/332,866. Such processes and compositions employ at least one raw material that is fibrous, and which acts as a microstructural template during reactive firing and produces an anisotropic microstructure in the final, fired ceramic article. However, raw materials are generally significantly more expensive to obtain in fibrous form than in powdered form, and the use of fibrous raw materials can therefore be economically unattractive.

### SUMMARY

In one aspect, embodiments of particle-loaded fibers are described. One embodiment of a particle-loaded fiber includes a fiber body having a plurality of inorganic particles bound together by an organic binder, where the fiber body has a diameter less than about 150 μm, and the inorganic particles comprise a particle density of greater than 20% by volume of the fiber body.

In another aspect, methods for producing a particle-loaded fiber are described. In one embodiment, a method for producing a particle-loaded fiber comprises: preparing a composition comprising an organic binder and inorganic particles, wherein the inorganic particles are greater than 50% by weight of the composition; extruding the composition through a die orifice having a diameter of less than 1000 μm to form a fiber having a first diameter; and drawing the fiber from the first diameter to a smaller second diameter, the second diameter less than 150 μm.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description present embodiments that are intended to provide an overview or framework for understanding the nature and character of the invention as it is claimed. The accompanying drawings are included to provide a further understanding of the principles and operations of the embodiments, and are incorporated into and constitute a part of this specification.

### DESCRIPTION OF THE DRAWINGS

FIG. 1 is a schematic illustration of a particle-loaded fiber as described herein.

FIG. 2A is a schematic illustration of one system that can be used to produce particle loaded fibers.

FIG. 2B is a schematic illustration of another system that can be used to produce particle loaded fibers.

FIG. 3 is a graph illustrating fiber diameter versus the particle content for Examples 1B, 2 and 3.

FIG. 4 is an image of a 70 μm diameter fiber loaded with 70 wt % alumina.

FIG. 5 is an SEM image of the fiber of FIG. 4, showing alumina particles in the polymer binder.

### DETAILED DESCRIPTION

Reference will now be made in detail to example embodiments which are illustrated in the accompanying drawings. Whenever possible, the same reference numerals will be used throughout the drawings to refer to the same or like parts.

This disclosure describes fibers composed of inorganic particles bound by an organic (e.g., polymer) material, and provides methods and systems for manufacturing such fibers. The amount of inorganic particles incorporated within the organic polymer binder can be between 20 and 70 volume percent of the volume of the fiber. In some embodiments, fibers as described herein may be used as raw materials in the production of ceramic products such as cordierite and aluminum titanate.

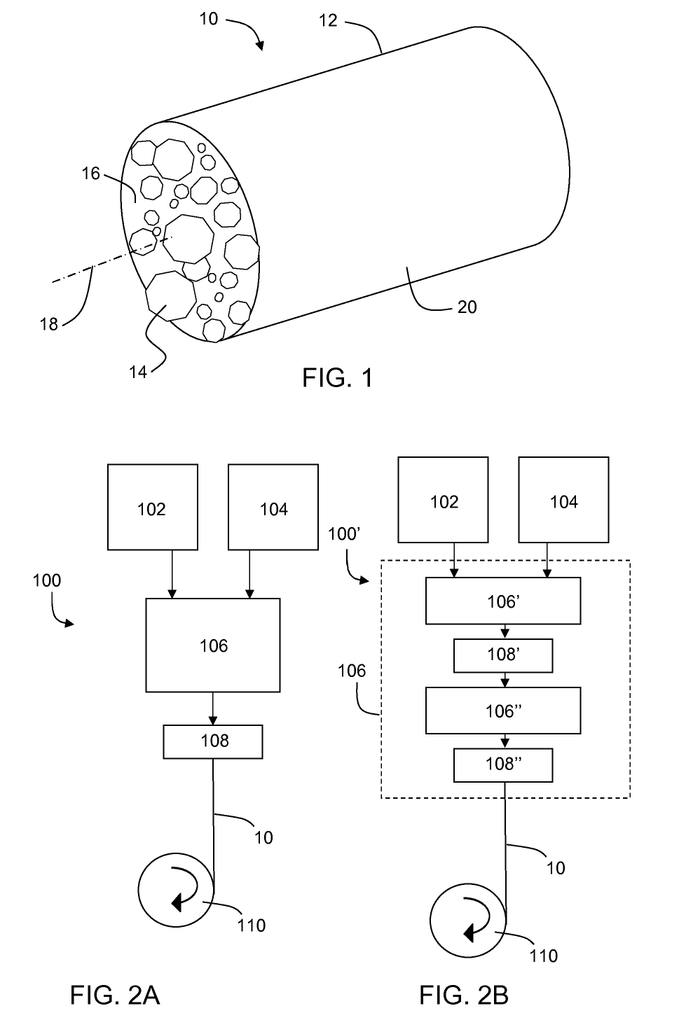

FIG. 1 is a schematic representation of a particulate-loaded fiber 10 according to the present disclosure. The fiber 10 includes an elongated body 12 formed of a plurality of inorganic particles 14 bound together by one or more organic binders 16. The body 12 extends along a longitudinal axis 18 and has an outer surface 20. Although the fiber body 12 is depicted in FIG. 1 as having a generally circular cross-sectional shape, fibers 10 according to the present disclosure may have any suitable cross-sectional shape, including an irregular cross-sectional shape.

In some embodiments, all or a portion of the inorganic particles 14 may be encapsulated (i.e., wholly contained) within the organic binder(s) 16. In some embodiments, a portion of the inorganic particles 14 may be only partially encapsulated in the organic binder(s) 16 such that a portion of the particles 14 are exposed at the outer surface 20 of the body 12. In one embodiment, the particles 14 are distributed generally uniformly throughout the fiber body 12.

In one embodiment, the inorganic particles 14 comprise greater than 20% by volume of fiber body 12. In other embodiments, the inorganic particles 14 comprise greater than 20% by volume, greater than 30% by volume, greater than 40% by volume, greater than 50% by volume, or even greater than 60% by volume of fiber body 12.

The volume percent of inorganic particles 14 in the fiber body 12 is the product of the ratio of the density of the fiber to the density of the inorganic particles and the weight percent inorganic particles:

$${V}_{particle} = \frac{{ρ}_{fiber}}{{ρ}_{particle}} {W}_{particle}$$

where V_{particle} is the volume percent of particles in the fiber, ρ_{fiber} is the density of the fiber, ρ_{particle} is the density of the particles, and W_{particle} is the weight percent of the particles.

The density of the fiber may be calculated using the relationship:

$${ρ}_{fiber} = \frac{1}{{\sum }_{i = 1}^{n} [ ( {W}_{i} / 100 ) / {ρ}_{i} ) ]}$$

where n is the number of batch components and i is the individual components, ρᵢ is the density of the component i, and Wᵢ is the weight percent of the component i.

The inorganic particles 14 of the fiber body 12 may have any suitable composition and may include metals, intermetallics, metal oxides, ceramics, glasses, minerals, etc. For example, the inorganic particles 14 may comprise alumina, ceria, zirconia, zeolite, silica, titanium dioxide, cordierite, aluminum titanate, silicon carbide, and silicon nitride, to name a few. In one embodiment, particles 14 in fiber 10 comprise a single material. In another embodiment, particles 14 in fiber 10 comprise more than one material.

Inorganic particles 14 may be characterized on the basis of their size. In one embodiment, particles 14 have a median particle size (D₅₀) greater than about 20 nanometers, greater than about 500 nm, or even greater than about 50000 nm. As used herein, the median particle size (D₅₀) represents the median or the 50th percentile of the particle size distribution, as measured by volume. That is, the D₅₀ is a value on the distribution such that 50% of the particles have a size of this value or less. Particle size may be accurately determined by any commercially available particle sizing equipment which uses, for example, dynamic light scattering, laser light diffraction, or electrical sensing methods. In another manner of characterizing the size of particles 14, the particle size may be described in relation to the diameter of the fiber body 12, which diameter may be less than about 200 μm, less than about 150 μm, less than about 100 μm, or even less than about 75 μm. For example, in some embodiments, the median particle size is more than 20% of the diameter of fiber body 12, more than 30% of the diameter of fiber body 12, more than 40% of the diameter of fiber body 12, or even more than 50% of the diameter of fiber body 12. For example, in one embodiment, the fiber body 12 has a diameter smaller than about 100 μm when the inorganic particles 14 have a median particle size greater than about 20 nanometers.

The one or more organic binder(s) 16 may have any suitable composition as described herein. In one embodiment, the organic binder 16 comprises a thermoplastic (e.g., polymer) material. Exemplary thermoplastic materials include, but are not limited to, polyesters, polyolefins, polycarbonates, polyamides, or mixtures thereof. In some embodiments, the organic binder 16 may include rheology modifiers and plasticizers to obtain the desired material properties. In some embodiments, a thermoplastic material for use as binder 16 may have a melt flow index (MFI) ranging from 5-15 g/10 min.

The fibers 10 as described herein are manufactured by methods that involve the extrusion and drawing of a thermoplastic melt stream from an orifice of a die. The particles are entrained within the thermoplastic melt stream as it is delivered to the die. As the thermoplastic melt stream and entrained particles are extruded through the die, the extruded fiber is placed on a rotary winder to draw down the fiber diameter. The particle-loaded fiber so produced may be considered a “green” fiber which can optionally be subjected to a pyrolysis and sintering process that removes the organic binder and densifies the inorganic materials to form a completely inorganic fiber. Therefore, in one embodiment, particles 14 may include sintering aids, such as transitional metal salts, organo-metallics, clays, high surface area metal oxides, magnesium oxide, silicone, silicon dioxide, rare earth oxides and transitional metal carbides, borides and nitrides.

FIG. 2A is a schematic diagram of one system 100 that can be used to produce fibers 10 as described herein. The system 100 includes at least one organic binder source 102 and at least one inorganic particle source 104. Binder source 102 and particle source 104 deliver binder 16 and particles 14 (e.g., a mixture that is 40-80% by weight particles), respectively, to an extruder 106 (e.g., a twin screw extruder) which, in turn, mixes and heats the composition above the melting temperature of the thermoplastic, and delivers the composition of particles 14 and binder 16 to an extrusion die 108 (e.g., a spinneret) having a die opening of less than about 1 mm (1000 μm), less than about 500 μm, or even less than about 400 μm. Also depicted in connection with system 100 is a fiber 10 being extruded from the die 108 and drawn (i.e., stretched) to a smaller diameter (e.g., about 20 μm to about 100 μm) by a rotary winder 110. Although only a single binder source 102 and single particle source 104 are depicted, it should be understood that other systems may include more than one binder source and/or more than one particle source. Similarly, although only a single fiber 10 is depicted, it should be understood that other systems may produce more than one fiber at the same time. In some embodiments, fibers 10 may be optionally coated with a material to prevent the fibers 10 from adhering to themselves, e.g., methylhydroxypropylcellulose, for example.

Although extruder 106 is depicted in FIG. 2A as a single element, it should be understood that system 100 may include any extrusion system or apparatus (including multiple extruders operated in tandem) capable of mixing and delivering the particles 14 and binder(s) 16 to the die 108. For example, with reference to FIG. 2B, a system 100′ having binder source 102 and particle source 104 may deliver particles 14 and binder 16 to a first extruder 106′ (e.g., a twin screw extruder) in which the particles 14 and binder 16 are mixed to form a generally homogenous composition. The composition of particles 14 and binder(s) 16 is heated above the melting temperature of the thermoplastic, extruded by first extruder 106′ through a first die 108′ (e.g., a 2 mm die orifice), cooled (e.g., by air or in a water bath), and then pelletized or powderized. After drying, the pelletized or powderized composition is fed into a second extruder 106″(e.g., a single screw extruder), heated above the melting temperature of the thermoplastic, and extruded through a second die 108″ (e.g., a spinneret) having a smaller diameter orifice (e.g., a die orifice of less than about 1000 μm, less than about 500 μm, or even less than about 400 μm) than the orifice of the first die 108′, and then drawn into fibers 10 having the smaller diameter (e.g., about 20 μm to about 100 μm) using rotary winder 110. The systems 100′ may be operated in a continuous manner to produce a highly loaded thermoplastic fiber by mixing the organic(s) and inorganic(s) in a twin screw mixer in tandem with a single screw extruder.

### EXAMPLES

The following non-limiting examples are provided to illustrate the principles described herein. The Examples describe particle loadings in terms of weight percent of the particles, which can be translated into volume percent of the extruded and drawn fiber using the relationships described above, specifically:

$${V}_{particle} = \frac{{ρ}_{fiber}}{{ρ}_{particle}} {W}_{particle}$$

$$and$$

$${ρ}_{fiber} = \frac{1}{{\sum }_{i = 1}^{n} [ ( {W}_{i} / 100 ) / {ρ}_{i} ) ]}$$

### Example 1A

A particle-loaded fiber was produced using an apparatus similar to that in FIG. 2B. Low density polyethylene (Exact 5371 Plastomer, Exxon Mobile, Melt flow index 10 g/10 min) was mixed in an 18 mm twin screw mixer (Leistritz) with particle loadings of 0, 60, 70 and 75 weight percent alumina (A1000 SG, Almatis) at a melting temperature of about 150 C and a screw speed of 100 RPM. The mixture was pelletized, then extruded with a single screw extruder (1″ Wayne 30:1 L/D ratio) through a 2 mm die orifice and drawn down to fibers having 150 μm to 200 μm diameters using a rotary winder (Nippon Serbig Calm PNS-112 Hyper Winder). Cooling water and air were used to control the cooling rates during drawing.

Using the relationships above, an alumina density of 4.0 g/cm³, and a polymer density of 0.87 g/cm³, the volume percent of the particles can be determined as follows:

For 60 wt. % alumina:

$${V}_{p} = \{ \frac{\frac{1}{[ \frac{( 40 \% / 100 )}{0.87 g \text{/} {cm}^{3}} ] + [ \frac{( 60 \% / 100 )}{4.0 g \text{/} {cm}^{3}} ]}}{4.0 g \text{/} {cm}^{3}} \} \cdot 60 \% = 25 \% ( volume )$$

For 70 wt. % alumina:

$${V}_{p} = \{ \frac{\frac{1}{[ \frac{( 30 \% / 100 )}{0.87 g \text{/} {cm}^{3}} ] + [ \frac{( 70 \% / 100 )}{4.0 g \text{/} {cm}^{3}} ]}}{4.0 g \text{/} {cm}^{3}} \} \cdot 70 \% = 34 \% ( volume )$$

For 75 wt. % alumina:

$${V}_{p} = \{ \frac{\frac{1}{[ \frac{( 25 \% / 100 )}{0.87 g \text{/} {cm}^{3}} ] + [ \frac{( 75 \% / 100 )}{4.0 g \text{/} {cm}^{3}} ]}}{4.0 g \text{/} {cm}^{3}} \} \cdot 75 \% = 40 \% ( volume )$$

### Example 1B

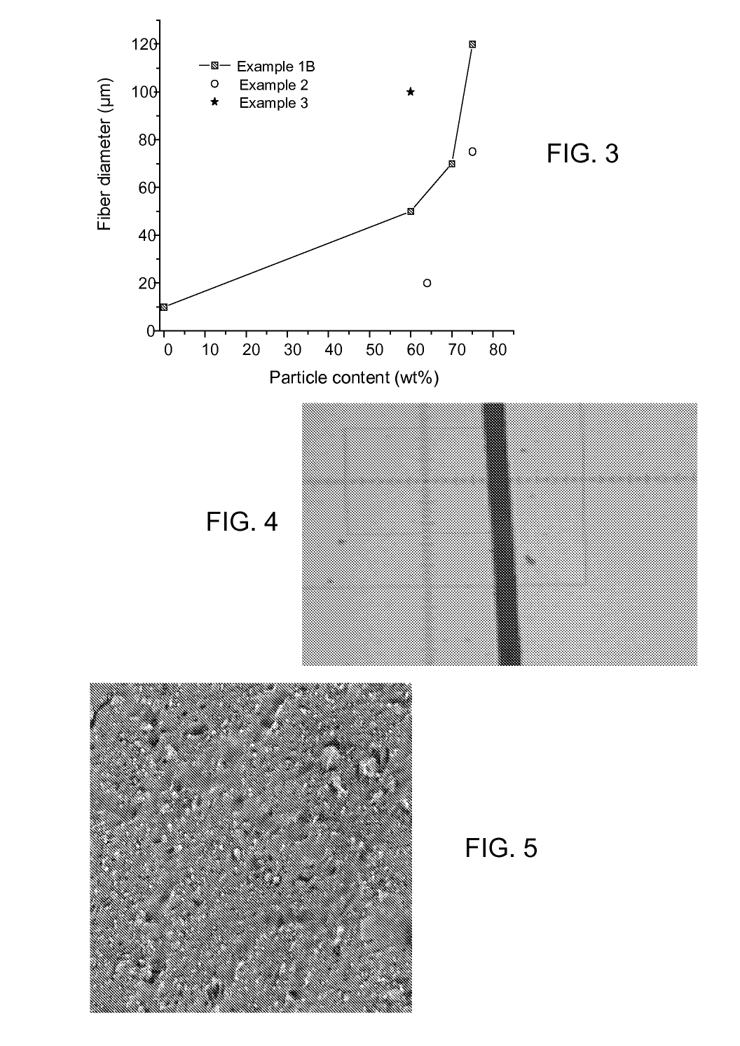

Using the process described in Example 1A, improved fiber stability and smaller diameter fibers were obtained by reducing the die orifice of the single screw extruder from 2 mm to 1 mm. Further improvements in fiber stability and reductions in fiber diameter were obtained by using a 0.4 mm (400 μm) orifice. No cooling water or air was required with the smaller orifices. Compared to the 2 mm die orifice of Example 1A, extrusion pressures increased 300 percent when using a 1 mm orifice and 1000 percent when using a 400 μm orifice. The process produced a continuous fiber within a stable process using the 400 μm die orifice at a temperature of about 100 C, screw speed of 10 RPM and winder speed of 60 RPM. Additional heating at the end of the die was used to prolong the drawing zone, and the fiber diameter was changed by increasing or decreasing the speed of the winder. As shown in FIG. 3, the diameter of the fiber during stable conditions increased at the higher loadings of alumina. An example of a fiber produced from a particle loading of 70 weight percent and having a diameter of 70 μm is shown in FIG. 4. As seen in FIG. 5, the alumina particles are well dispersed in the polymer matrix.

### Example 1C

Using the process described above in Examples 1A and 1B, low density polyethylene (Exact 5371 Plastomer, Exxon Mobile, Melt flow index 10 g/10 min) was mixed in an 18 mm twin screw mixer (Leistritz) with particle loadings of 60 weight percent alumina (as-received A1000 SG, Almatis). Fiber with diameter of 70-90 microns was produced using a continuous fiber drawing process using at a die temperature of about 120 C, a screw speed of 9 RPM and a winder speed of 60 RPM

### Example 1D

The process of Example 1C was repeated with a particle loading of 66 weight percent and an additional heater provided at the end of the die to increase the drawing zone and allow further decrease of the diameter of the fiber. The additional heater allowed the fiber to be drawn to diameter of 15-40 microns.

### Example 1E

The process of Examples 1A and 1B was repeated using a polyolefin plastomer (Affinity PL 1880, Dow) as the organic binder and particle loadings of 60, 70 and 80 weight percent alumina (A1000 SG, Almatis). The compound provided a more rigid fiber and reduced fiber diameter. Using the relationships above, it can be calculated that the fiber formed from the 80 wt. % alumina has a 46.5 vol. % alumina.

### Example 2

Low density polyethylene (Exact 5371 Plastomer, Exxon Mobile, Melt flow index 10 g/10 min) and poly (ethylene-co-propylene) (JQDB 2230 NT, Dow) were mixed in an 18 mm twin screw mixer as described in Example 1B, with 0, 64 and 75 weight percent loadings of alumina (A1000 SG, Almatis) at a melting temperature of about 180 C and a screw speed of 70 RPM. The mixture was pelletized and then extruded with a single screw extruder at lower velocity thru a 400 μm die orifice at a die temperature of about 145° C., screw speed of 7 RPM and winder speed of 60 RPM. The 64% loaded polymer blend had a fiber diameter between 10 and 40 μm, while and the 75% loaded polymer blend had a diameter of 70-80 micrometers (FIG. 3).

### Example 3

Using the process of Example 1B, low density polyethylene (Exact 5371 Plastomer, Exxon Mobile, Melt flow index 10 g/10 min) was mixed with 60 weight percent inorganic particles containing ceria, zirconia and zeolite. The extruded and drawn green fiber had a diameter of 100 micrometers (FIG. 3). These fibers were coated with methylhydroxypropylcellulose and water solution, allowed to dry, heated to 800° C. for firing and held at temperature for 3 hours prior to being cooled. The fired fibers had a diameter of 120 micrometers.

### Example 4

High density polyethylene (Icoflow HD 25-500, Icotex) was mixed with Mg(OH)₂ (Magnifin H-10, Martinswerk GMBH) at 50, 60, 70, and 80 weight percent particle loadings. As described in Example 1A, the mixture was extruded through a die orifice of >2 mm on an 18 mm twin screw extruder at a die temperature of 150° C. and screw speed of 120 RPM. The processing of this composition required screw torque and melt pressure that were 2-3 times lower than earlier Examples. After palletizing and drying, the compound was extruded on a single screw extruder thru a 1 mm diameter die orifice and the fiber had good strength (as qualitatively evaluated) and smooth surface (as revealed by scanning electron microscope). The fiber was cooled in a water bath placed about 10 cm away from the die exit to reduce the melt flow instabilities and increase productivity.

The present disclosure describes a composite fiber having inorganic particles highly loaded in an organic binder, such as a thermoplastic polymer. The fiber and fiber producing methods described herein beneficially use low cost precursors (i.e., inexpensive polymers and inorganic particles). The methods permit a continuous fiber making process, and allow fiber diameter control. The methods are also conducive to using any inorganic material without generating chemical byproducts other than pyrolysis gasses of the organic binder when the green fiber is optionally subjected to a pyrolysis and sintering step which removes the organic binder and densifies the inorganic materials to form an inorganic fiber. The present disclosure thus provides a highly versatile fiber making process and fibers that meet the needs for fibrous precursors for ceramic articles such as particulate filters, catalytic substrates, and refractory insulation. In some embodiments, precursors may be selected such that the above-described process can be used to generate high strength fibers as may be desired for reinforcement fibers.

While the article and method have been described with respect to several embodiments and examples, various modifications, additions, and variations will become evident to persons of skill in the art without departing from the spirit and scope of the invention as it is claimed. Thus it is intended that the present disclosure cover such modifications and variations provided they come within the scope of the appended claims and their equivalents.

What is claimed is:

1. A particle-loaded fiber comprising a fiber body that comprises a plurality of inorganic particles bound together by an organic binder, wherein the fiber body has a diameter less than about 150 μm, and the inorganic particles comprise a particle density of greater than 20% by volume of the fiber body.

2. The fiber of claim 1, wherein the inorganic particles comprise a particle density of greater than 30% by volume of the fiber body.

3. The fiber of claim 1, wherein the inorganic particles comprise a particle density of greater than 40% by volume of the fiber body.

4. The fiber of claim 1, wherein the inorganic particles comprise a particle density of greater than 50% by volume of the fiber body.

5. The fiber of claim 1, wherein the fiber body has a diameter less than about 100 μm.

6. The fiber according to claim 1, wherein the inorganic particles have a median particle size of greater than about 20 nanometers.

7. The fiber according to claim 1, wherein the plurality of particles have a median particle size in the range of about 20 nanometers to about 10 μm.

8. The fiber according to claim 1, wherein the organic binder comprises one or more thermoplastic material.

9. The fiber according to claim 8, further comprising organic rheology modifiers and plasticizers.

10. The fiber according to claim 8, wherein the thermoplastic material comprises at least one of a polyester, a polyolefin, a polycarbonate, or a polyamide.

11. The fiber according to claim 1, wherein the inorganic particles comprise at least one of alumina, ceria, zirconia, zeolite, silica, titanium dioxide, cordierite, aluminum titanate, silicon carbide, and silicon.

12. The fiber according to claim 1, wherein the inorganic particles comprise one or more sintering aids.

13. A method of producing a particle-loaded fiber, comprising:
preparing a composition comprising an organic binder and inorganic particles, wherein the inorganic particles are greater than 50% by weight of the composition;
extruding the composition through a die orifice having a diameter of less than 1000 μm to form a fiber having a first diameter; and
drawing the fiber from the first diameter to a smaller second diameter, the second diameter less than 150 μm.

14. The method of claim 13, wherein the organic binder comprises a thermoplastic material, and further comprising heating the composition above the melting temperature of the thermoplastic material.

15. The method of claim 13, wherein preparing the composition comprises:
compounding the organic binder and inorganic particles in a first extruder;
performing one of pelletizing and powderizing of the compounded binder and particles; and
providing the pelletized or powderized compound to a second extruder for extruding into the fiber.

16. The method of claim 15, wherein the first extruder is a twin screw extruder and the second extruder is a single screw extruder.

17. The method of claim 13, further comprising coating the fibers with methylhydroxypropylcellulose to minimize adhesion of the fibers to each other.

18. The method of claim 13, wherein the inorganic particles are greater than 60% by weight of the composition.

19. The method of claim 13, wherein the inorganic particles are greater than 65% by weight of the composition.

20. The method of claim 13, wherein the inorganic particles are greater than 70% by weight of the composition.

21. The method of claim 13, wherein extruding the composition through a die orifice comprises extruding through a die orifice having a diameter of less than 500 μm.
